(19) United States
(12) Patent Application Publication
(10) Pub. No.: US 2020/0272959 A1
(43) Pub. Date: Aug. 27, 2020

(54) Tracking Movement of Resources in a Financial Transaction Network

(71) Applicant: Northeastern University, Boston, MA (US)

(72) Inventors: Carolina E. Mattsson, Jamaica Plain, MA (US); Guy Stuart, Washington, DC (US)

(21) Appl. No.: 16/796,332

(22) Filed: Feb. 20, 2020

Related U.S. Application Data
(60) Provisional application No. 62/809,359, filed on Feb. 22, 2019.

(51) Int. Cl. G06Q 10/06; G06Q 20/40; G06Q 20/02; G06Q 20/10

(52) U.S. Cl. CPC G06Q 10/063; G06Q 20/10; G06Q 20/023; G06Q 20/4016

(57) ABSTRACT

Financial transactions in a centralized clearing system generate substantial data, which presents challenges to finding useful information about those transactions. From a transaction data set, trajectories are defined, each of the trajectories having a source and a destination and indicating a flow of a given resource through at least one via point based on a plurality of transactions of the transaction data set. The given resource can be a function of the transferred amounts of the plurality of transactions. A map relating the trajectories based on common sources and destinations is generated, and a network analysis is then applied to the map to produce analytics of the transactions. From the analytics, useful information about the transactions, such as instances of potential fraud, can be reported.

### RELATED APPLICATIONS

This application claims the benefit of U.S. Provisional Application No. 62/809,359, filed on Feb. 22, 2019. The entire teachings of the above application are incorporated herein by reference.

### GOVERNMENT SUPPORT

This invention was made with government support under grant no. 1451070 from the National Science Foundation. The government has certain rights in the invention.

### BACKGROUND

Payment systems are the foundation of the global financial system. In the modern economy, payment systems range in scale from local credit arrangements, to digital payment platforms, to national payment systems, all of which are knitted together into an elaborate financial infrastructure. In addition to their importance, payment systems bridge economics and finance. Payment systems facilitate economic activity every day, but they also enforce financial constraints, as anyone who has had a check bounce or a debit card declined can attest. And while individual transactions are quintessentially microeconomic, their collective effect on the payment systems in which they take place have marcoeconomic implications.

Payment processing systems passively record everyday economic activity at its most basic unit—individual transactions. Financial transaction data from these systems describe microeconomic actions at macroeconomic scales in an inherently networked manner. Payment processing infrastructure is becoming increasingly digital in nature, and this movement is changing how payment systems can be understood.

### SUMMARY

Example embodiments provide for transforming transaction data into a useful representation, such as representative paths over which units of value (e.g., money) have been observed to move. Each account associated with transactions may be given a heuristic by which it assigns incoming funds to outgoing funds, thereby enabling every unit of value to be properly accounted for. Instead of analyzing transactions on an individual basis, this data transformation allows for analysis of the movement of units of value within a payment system from where it enters to where it leaves. For example, a $100 deposit transaction that is directly followed by a $100 payment transaction from the same account can be represented as a $100 moving through that account along a deposit-payment path.

Example embodiments include a computer-implemented method of analyzing transactions in a centralized clearing system. Representations of individual transactions of units of value may be converted into representations of trajectories representing a reduced number of units of value, the representations of trajectories composing flow paths of the units of value from origins to destinations. A coarse graining computer-implemented method may be applied to the representations of trajectories, the coarse graining computer-implemented method producing a reduced number of representations of trajectories that compose a flow network from the origins to the destinations. A network analysis may then be applied to the flow network to produce analytics of the transactions in the centralized clearing system.

Trajectories may be categorized prior to applying the coarse graining, the categorizing assigning the representation of trajectories into categories of transaction type sequences including at least a) deposit and payment/withdrawal, and b) deposit, transfer, and payment/withdrawal. At least a subset of flow paths may include via points between the origins and destinations, and the coarse graining may remove at least a subset of the via points. A subset of via points or constituent transactions may be reintroduced after applying the coarse graining responsive to an automated or user input. The representations of trajectories, or analytics, may be displayed at a graphical user interface (GUI). At least a subset of the representations in the GUI may be displayed with color coding, geographical markers, or indicia highlighting a feature of the analytics.

The transactions may include transfers of tangible or intangible units of value, the intangible units of value including at least one financial instrument of money, bonds, and stocks. Based on the analytics of the transactions, at least one violation may be identified, the violation including at least one of a fraud, money laundering, and terrorism financing.

Further embodiments include a computer-implemented method of processing financial transactions. A transaction data set may be obtained, wherein entries of the transaction data set may include a sender, a recipient, and a transferred amount. Trajectories may be defined from the transaction data set, wherein each of the trajectories may have a source and a destination and indicating a flow of a given resource through at least one via point based on a plurality of transactions of the transaction data set. The given resource may be a function of the transferred amounts of the plurality of transactions. A violation may then be identified based on whether a metric of at least one of the trajectories exceeds a predetermined threshold, and the violation may be reported to a user.

The at least one via point may indicate an entity identified as 1) a recipient in a first transaction and 2) a sender in a second transaction. Defining the trajectories may include defining a trajectory integrating the first and second transactions, the trajectory indicating the flow of the given resource from a sender in the first transaction to a recipient in the second transaction.

A course-graining may be applied to the trajectories, the coarse-graining including eliminating the at least one via point from the trajectories. The coarse-graining may also include combining a plurality of trajectories into a combined trajectory based on at least one of a common source, a common destination, and a common time range. A resource amount of the combined trajectory may be determined based on at least one of resource amounts of each of the plurality of trajectories and the resource amount of the plurality of associated transactions. A resource amount of the combined trajectory may also be determined based on the resource amounts of each of the plurality of trajectories.

The trajectories may be categorized into a plurality of categories of transaction type sequences, the categories including at least one of 1) deposit and payment/withdrawal, 2) deposit, transfer, and payment/withdrawal. The trajectories may also be categorized into a plurality of categories based on at least one of 1) total duration, 2) resource amount, and 3) location.

At least one transaction of the transaction data set associated with the violation may be identified, and a report of the violation may include an indication of the at least one transaction. The trajectories may be filtered based on at least one of source, destination, resource quantity, duration, and transaction type sequence. A map relating the trajectories based on common sources and destinations may be generated. At least one of the trajectories may be a function of a fee assessed by a payment system for transferring the given resource. The trajectories may be defined based on at least one of a last-in-first-out allocation and a well-mixed allocation of the resource.

Still further embodiments include a computer-implemented method of processing financial transactions. A transaction data set may be obtained, entries of the transaction data set including a sender, a recipient, and a transferred amount. Trajectories may be defined from the transaction data set, each of the trajectories having a source and a destination and indicating a flow of a given resource through at least one via point based on a plurality of transactions of the transaction data set. The given resource may be a function of the transferred amounts of the plurality of transactions. A map relating the trajectories based on common sources and destinations may be generated. A network analysis may then be applied to the flow network to produce analytics of the transactions in the centralized clearing system, and the analytics may be reported to a user.

Further embodiments include a computer-implemented method of ranking and segmenting accounts in a centralized clearing system. A data set of transactions processed by the centralized clearing system may be obtained, entries of the transaction data set including a sender, a recipient, and a transferred amount. Representations of individual transactions of units of value may be converted into representations of trajectories composing flow paths of the units of value from origins to destinations via at least one account of the centralized clearing system. At least one metric defined for a plurality of accounts may be generated, the metric being constructed for each account based on the one or more trajectories where that account is a via point, the metric thereby characterizing the behavior of accounts with respect to the flow of units of value. A sorting or clustering analysis may then be applied to at least one metric for a plurality of accounts, having this analysis return a ranking or segmentation of accounts. The account ranking or segmentation may then be reported to a user.

A timestamp included in the transaction data set may be incorporated to define a duration at each account along each flow path, the metric being constructed for each account based on the duration of time where that account is a via point for one or more trajectories. The metric may be defined based on ancillary entries of at least one transaction of the transaction data set associated with the trajectories where that account is a via point.

It should be understood that example embodiments of the invention are described in the context of monetary movement across a digital payment network. The embodiments may also be applied to records of other forms of flow across a network.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram illustrating a financial network in which example embodiments may be implemented.

FIG. 2 is a block diagram of a server in an example embodiment.

FIG. 3 is a table illustrating transaction data in one embodiment.

FIG. 4 is a flow diagram of a process of analyzing transactions in one embodiment.

FIG. 5 is a map of transactions in one embodiment.

FIG. 6 is a table illustrating trajectory data in one embodiment.

FIG. 7 is a trajectory map in one embodiment.

FIG. 8 is a table summarizing the mobile money transaction data in one embodiment.

FIG. 9 is a map of transactions in one embodiment.

FIG. 10 illustrates sub-networks of trajectories in one embodiment.

FIG. 11 is a graph depicting the distribution of trajectory durations.

### DETAILED DESCRIPTION

A description of example embodiments follows.

Payment processing systems passively record everyday economic activity at its most basic unit—individual transactions. Financial transaction data from these systems describe microeconomic actions at macroeconomic scales in an inherently networked manner. Example embodiments, described herein, provide temporal network analysis to financial transaction data from payment systems. Transactions also describe the literal movement of money, which must obey basic accounting constraints. Balance-respecting trajectories, as described herein, explicitly represent observed flows of money through a payment system. Observed trajectory motifs correspond closely to known use-cases of payment systems: payments, money transfer, and money storage. These different motifs move money through the system to form different network structures at the system scale, and also reveal violations of the payments systems such as fraudulent behavior.

Example embodiments implement trajectory-based temporal network approaches to the specific nature of money. For individual users, financial transactions are instantaneous links in continuous time that move money into or out of their accounts. Crucially, an individual cannot send a transaction unless they have the required amount of money in their account. Payment systems are what enforce this basic accounting constraint, in practice, whether in a decentralized manner (cash), a centralized manner (checking), or even algorithmically (blockchain). The system-wide effect of accounting is to guarantee that the volume of money is conserved, making the movement of money akin to flow of an incompressible fluid. By incorporating this constraint at the individual level, a sequence of financial transactions can be transformed into to a set of balance respecting trajectories that explicitly represent the observed flow of funds.

Trajectories representing the flow of units of value intuitively summarize transaction data, isolating known use-cases of payment system: payments, transfers, and deposits. Using trajectories, circulation of money can also be quantified. Trajectories may also be aggregated, which can reveal that different use-cases create notably different structures of money flow at the system scale. For example, payments may result in a hub-and-spoke network, money transfers form a largely amorphous network, and money storage builds a network with richer meso-scale structure based primarily on geography. Analysis of the money storage sub-network may also uncover fraudulent behavior such as systematic fee evasion.

Payment systems passively record massive amounts of economic activity all over the world, every day, in the form of financial transactions, but empirical study of these systems has lacked a principled framework for descriptive analysis. Balance-respecting trajectories relates observed structure with observed behavior, bringing this exciting new class of data into reach for the powerful tools of network science, while remaining interpretable as the circulation of money. This framework provides for facilitating descriptive work on financial transaction data from any payment system, encouraging further study of the underlying structure of economic activity at its most elemental.

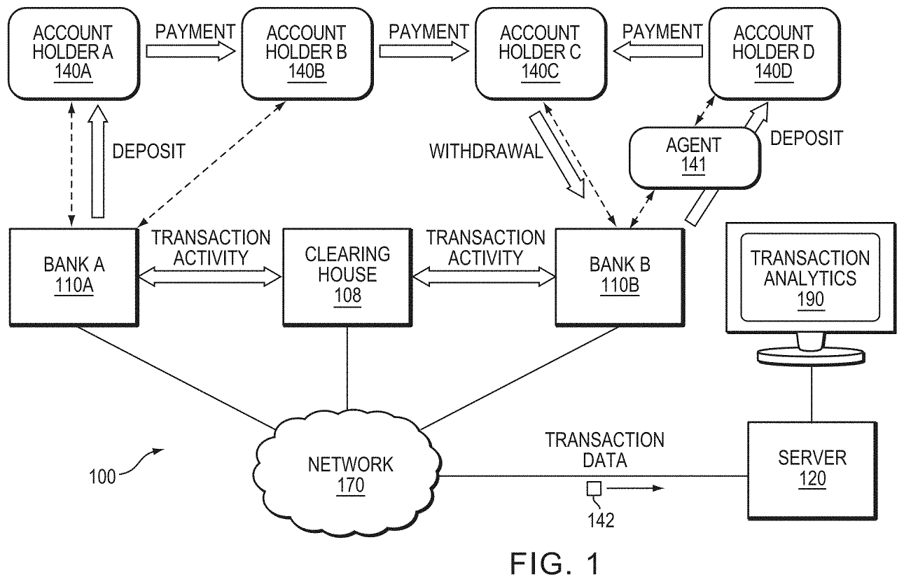

FIG. 1 is a diagram illustrating a financial network 100 in which example embodiments may be implemented. The network 100 includes banks 110A-B, which may accept deposits of money and/or other units of value, creates credit, and maintain accounts for individuals, businesses and/or other entities. The banks 110A-B may include traditional banking institutions as well as other companies or entities engaged in storing or transferring money or other units of value, such as mobile payment services. A clearing house 108 (e.g., an automated clearing house (ACH)) may facilitate money transfers between accounts maintained by the banks 110A-B. The banks 110A-B and clearing house 108 may communicate with one another via an electronic network 170 (e.g., the Internet).

A plurality of account holders 140A-D may possess accounts at one or more of the banks 110A-B, and may access their accounts to make deposits into their accounts, withdraw money from their accounts, and make a payment to another account holder. To access their accounts, the account holders 140A-D may visit a bank 110A-B in person, through a telephone call, through an agent 141 such as a mobile money agent, or through a web page or mobile app in communication with the bank 110A-B via the Internet. For example, account holder A 140A may access his/her account at bank A 110A through a web page to deposit money into the account, and may also make a payment to account holder B 140 from the account.

In facilitating the payments, deposits, withdrawals and other activity ordered by the account holders, the banks 110A-B may generate and store data about those transactions, including an indication of the sending account (if applicable), the receiving account (if applicable), the time of the transaction, and the amount of the transaction. A server 120, in communication with the network 170, may access this data as transaction data 142 from the banks 110A-B and/or the clearing house 108.

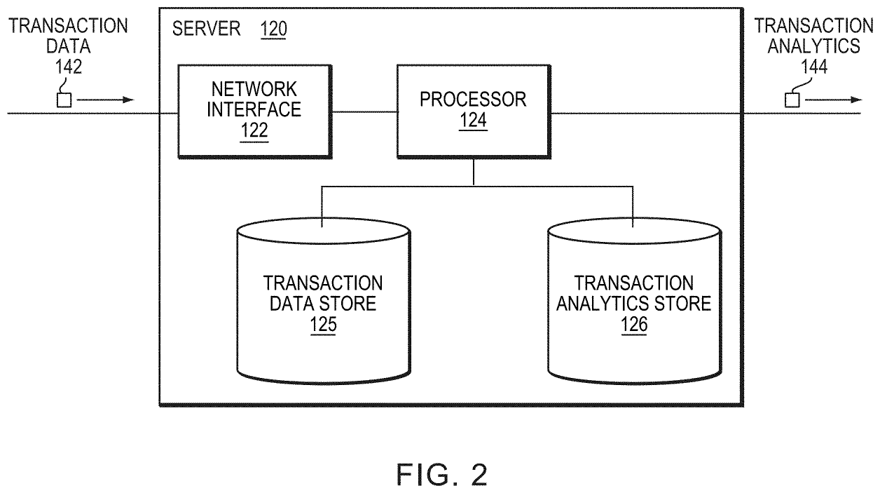

FIG. 2 illustrates the server 120 in further detail. The server 120 may include a network interface 122 for communicating with the banks 110A-B and/or the clearing house 108 across the network 170 and collect the transaction data 142. A processor 124 may store the transaction data 142 to a transaction data store 125 in its entirety or as a reduced data set. The processor 124 may also perform processing, analysis, filtering and/or evaluation operations on the transaction data 142 as described in further detail below, to transaction analytics 144. The processor 124 may store some or all of the transaction analytics 144 to the transaction analytics store 126, and may output the transaction analytics 144 for presentation to a user at a display 190 or other device.

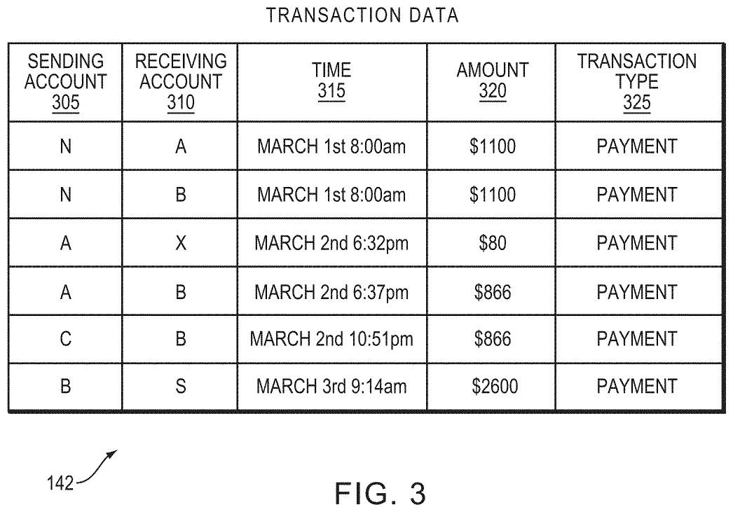

FIG. 3 is a table 1 illustrating example transaction data 142 that may be collected and processed by the server 120. With reference to FIG. 1, each entry of the table may identify a specific transaction (e.g., deposit, withdrawal, payment) made by the account holders 140A-D during a given time interval, and may include indications of a sending account 305 (where applicable), indications of the receiving account 310 (where applicable), a transaction time 315, an amount transacted 320 (e.g., in units of currency or other units of value), and a transaction type 325 (e.g., payment, deposit, withdrawal). Alternatively, the transaction type 325 may be omitted from the transaction data 142, and instead may be inferred from other information of the transaction data 142 (e.g., the sending and/or receiving account information). The banks 110A-B and/or clearing house 108 may store, maintain and update the transaction data 142 as electronic records, and may transfer the transaction data to the server 120 for processing and analysis.

In further embodiments, the transaction data 142 may include an indication of one or more geographic locations at which the transactions occurred. Such location data may correspond to the geographic location(s) of the bank(s) 110A-B facilitating the transaction, and/or may provide a known or estimated location of the account holder(s) 140A-D that are participants in the transaction. For example, location data may indicate the general location (e.g., ZIP code) of the account holder(s), an address of the account holder as maintained by the banks 110A-B, or may indicate an estimated geographic location based on the device (e.g., a mobile device) used by the account holder 140A-D to access his/her account and order the transaction.

The banks 110A-B may provide services for thousands or millions of individual account holders, each of which may order several transactions per day. As a result, the transaction data 142 collected by the banks over time may become exceedingly large. Moreover, because the individual transactions are accounted for separately, the transaction data itself may fail to clarify associations between related transactions, and may fail to distinguish unrelated transactions. As a result, the characteristics of the transaction data 142 may hinder efforts to determine useful information about the transactions as a whole, such as the movement of various quantities of money between entities evident from several transactions. Further, it may be difficult to detect and discern the nature of violations such as fraud, money laundering, and terrorism financing. Example embodiments, described in further detail below, provide solutions for processing transaction data to produce analytics of transactions that may provide users with a range of useful information about the movement of money or other units of value between entities.

In one embodiment, a computer-implemented process, implemented by the server 120 or another computing device, transforms a sequence of financial transactions into a set of weighted trajectories of money that respect both time and accounting constraints, referred to herein as “balance-respecting trajectories.” The transformation can be implemented using dynamic programming based on intermediate objects, “branches,” that represent portions of transactions. Root branches are portions of transactions that begin trajectories. As new transactions appear, existing branches provide the funds to service them according to a “transformation heuristic,” building up a tree-like structure of references. Leaf branches are portions of transactions that end trajectories. Once a leaf branch is reached, the computer implemented method has uncovered a complete trajectory and recursively traverses back toward the root branch. The sequence of transactions, nodes, and durations encountered on the way back to the root branch becomes the basic features of a balance-respecting trajectory. This process can be implemented concurrently for all accounts in the system as transactions appear in sequence or in continuous time.

Two aspects of this solution may be defined: the “network boundary” and the “transformation heuristic.” The network boundary determines what transactions, or parts of transactions, are defined to begin and end trajectories and must be interpreted from the data. In many cases, transaction types supplied in the data itself can be used to make the determination. For example, transactions types that deposit money onto user accounts can be defined to be root branches, withdrawal transaction types as leaf branches, and remaining types as keeping funds in circulation. Finite data considerations will mean that it is not always known where specific funds originated. In such a case, the computer-implemented method will create a root branch, effectively inferring the prior existence of the funds.

The transformation heuristic determines which existing funds get assigned to which outgoing transactions. For example, a greedy heuristic that implements last-in-first-out would dictate that an account that deposits $100 at an ATM and then promptly pays a $100 bill will generate a straightforward $100 trajectory from the ATM that processed their deposit, through their account, and on to the utility. A second option that may be more appropriate in other settings is a well-mixed heuristic that allocates outgoing funds by pulling evenly from all branches currently in that account. In the context of network science, this approaches the notion of a random walk in that it recovers all possible trajectories that a unit of money could have taken through the system, and gives trajectories a size that corresponds to their relative likelihood. In addition to the above examples, other transformation heuristics that conforms to basic accounting constraints can produce balance-respecting trajectories under example embodiments.

Further embodiments may encompass various modifications to the aforementioned data transformation process, including 1) introducing duration or amount cutoffs; 2) ensuring that account balances remain consistent with data; and 3) accounting for fees paid to the payment processing provider. Such embodiments may also encompass aggregating balance-respecting trajectories into an entry-exit network, (e.g., mapping the movement of money through a payment system from roots to leaves).

Example embodiments provide for capturing information in sequential transactions, and can capture transaction data under different configurations that are recorded under a range of different recording practices. By generating trajectories and corresponding analytics from the transaction data, example embodiments can provide a more intuitive representation of transaction data, which is a representation that avoids double-counting of transactions. Example embodiments can also expose how money moves within payment systems, including from where money is deposited to where it is withdrawn. The extent to which money is circulating within the boundaries of a payment system can also be quantified. Example embodiments can be implemented in various applications such as 1) financial fraud detection, 2) the mapping and analysis of payment processing systems, such as those run by banks, central banks, and fintech companies, and 3) benchmarking and tracking the performance of payment processing systems.

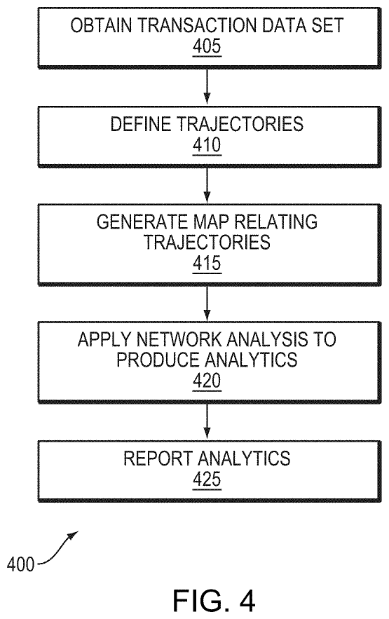

FIG. 4 is a flow diagram of a process 400 of analyzing transactions in one embodiment. With reference to FIGS. 1-3, the server 120 may obtain a transaction data set (e.g., transaction data 142) from one or more banks 110A-B and or the clearing house 108 (405). The server 120 may define trajectories from the transaction data 142, wherein each of the trajectories have a source and a destination and indicate a flow of a given resource (e.g., money) through one or more via points based on multiple transactions of the transaction data set (410). The via points may indicate an entity identified as 1) a recipient in a first transaction and 2) a sender in a second transaction. The amount of the given resource for the trajectories may be a function of the transferred amounts of the underlying transactions. One or more of the trajectories may be a function of a fee assessed by a payment system for transferring the given resource. The server 120 may define the trajectories based on a last-in-first-out allocation and/or a well-mixed allocation of the resource. Further, the server 120 may apply a course-graining to the trajectories, which may eliminate the via points from the trajectories. The coarse-graining may also include combining multiple trajectories into a combined trajectory based on a common source, a common destination, and/or a common time range. The server 120 may determine a resource amount of the combined trajectory based on the resource amounts of each of the trajectories and the resource amount of the associated transactions. A resource amount of the combined trajectory may also be determined by the server 120 based on the resource amounts of each of the plurality of trajectories.

The server 120 may then generate a map relating the trajectories based on common sources and destinations (415). The server 120 may apply a network analysis to the map to produce analytics of the transactions (420), and the analytics may be reported to a user (425). For example, the server 120 may categorize the trajectories into a plurality of categories of transaction type sequences, such as 1) deposit and payment/withdrawal, and 2) deposit, transfer, and payment/withdrawal. The trajectories may also be categorized into a plurality of categories based on total duration, resource amount, and/or location. The server 120 may also filter the trajectories based on a respective source, destination, resource quantity, duration, and transaction type sequence. Following such processing, the server 120 may update the map (or generate an additional map) relating the trajectories based on common sources and destinations. Further example analytics are described in further detail below.

As a component of the analytics, the server 120 may identify and report a violation based on whether a metric of at least one of the trajectories exceeds a predetermined threshold. The violation may identify a potential instance of fraud, money laundering, and terrorism financing. A transaction associated with the violation may be identified, and a report of the violation may include an indication of the at least one transaction.

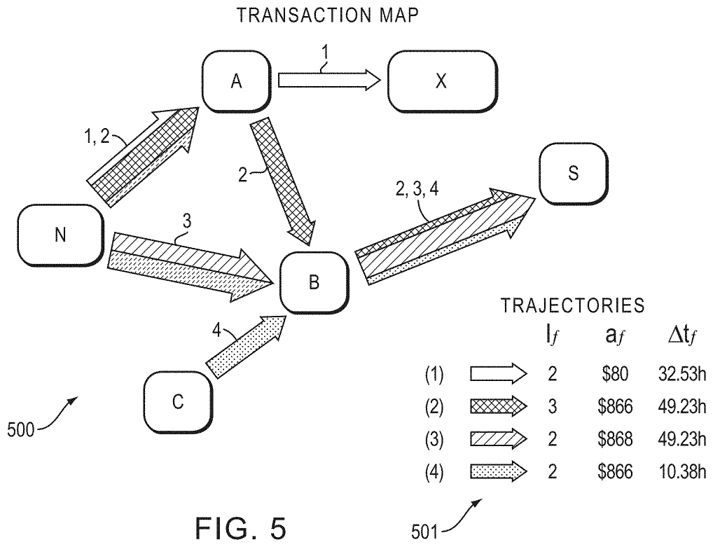

FIG. 5 is a map 500 of transactions that may be generated by the server 120 based on the example transaction data 142 shown in FIG. 3. Here, each account holder (A-C, N, S, X) is represented as a single node of a network, and the transactions between the account holders are represented by connectors (e.g., arrows) indicating a direction of payment from one node to another node. In further embodiments, banks, payment services, and other financial institutions may also be represented as nodes of the network. The connectors may be depicted as visually distinct from one another based on amount transferred, time of transfer, or other characteristics of the transactions. For example, as shown, the arrows have a width that is proportional to the amount being transferred.

In performing the trajectory analysis described above, the server 120 may identify four trajectories (identified as (1)-(4)) from the transactions. In particular, trajectory (1) extends from N to X via A; trajectory (2) extends from N to S via A and B; trajectory (3) extends from N to S via B; and trajectory (4) extends from C to S via B. In response to identifying the trajectories, the server 120 may update the connectors to identify those trajectories. For example, as shown, some of the arrows are divided into multiple segments to indicate that the transaction transfers money that is associated with multiple trajectories. For example, the connection between B and S is associated with trajectories 2, 3 and 4. A key of the trajectories is illustrated at bottom right, and indicates the length I_{f} (in nodes), amount a_{f} (in currency or other units of value), and total duration Δt_{f} (in hours) of the trajectories.

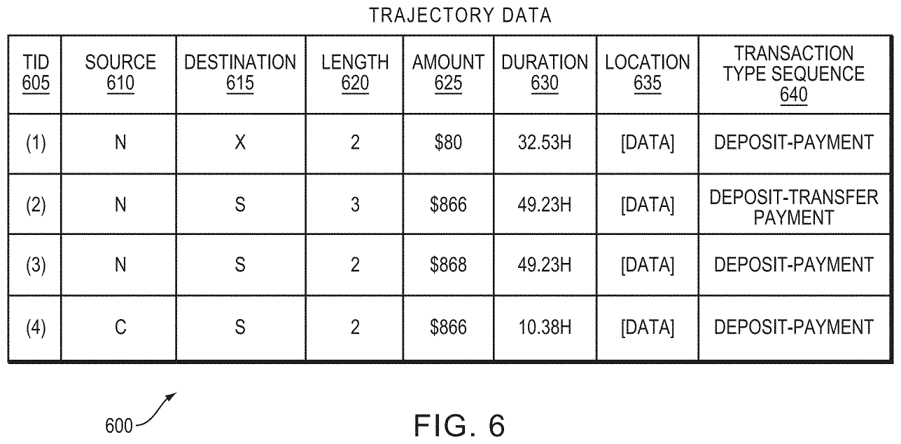

FIG. 6 is a table illustrating trajectory data 600 that may be generated by the server 120 for trajectories (1)-(4) illustrated in FIG. 5. Each entry of the table may identify a specific trajectory identified by the server, and may include indications of a trajectory identifier 605, a source (node/account holder at which the trajectory begins) 610, destination (node/account holder at which the trajectory ends), length (number of nodes in trajectory following the source) 620, amount (in currency or other units of value) 625, total duration (in hours) from the first transaction to the last transaction underlying the trajectory 630, location data 635, and transaction type sequence 640. The location data 635, as described above, may correspond to the geographic location(s) of the bank(s) facilitating the transaction, and/or may provide a known or estimated location of the account holder(s) that are participants in the transactions underlying the trajectory. Optionally, the location data 635 may indicate known or estimated geographic locations corresponding to the source, destination and/or via points, thereby indicating a directional flow of the resource underlying the trajectory across different geographic regions. The server 120 may determine and assign the transaction type sequence 640 to each trajectory based on the transaction types (e.g., deposit, withdrawal, payment) of the transactions associated with the trajectory. For example, the server 120 may assign transaction type sequences in the categories of 1) deposit and payment/withdrawal, and 2) deposit, transfer, and payment/withdrawal.

The trajectories may also be categorized into a plurality of categories based on total duration, resource amount, and/or location. The server 120 may also filter the trajectories based on a respective source, destination, resource quantity, duration, and transaction type sequence. Following such processing, the server 120 may update the map (or generate an additional map) relating the trajectories based on common sources and destinations. Further example analytics are described in further detail below.

As a component of the analytics, the server 120 may identify and report a violation based on whether a metric of at least one of the trajectories exceeds a predetermined threshold. The violation may identify a potential instance of fraud, money laundering, and terrorism financing. A transaction associated with the violation may be identified, and a report of the violation may include an indication of the at least one transaction.

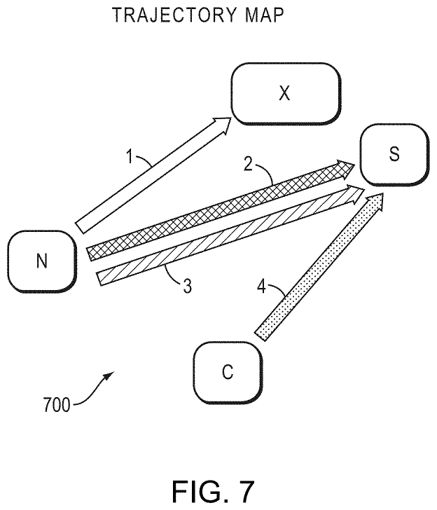

FIG. 7 illustrates a trajectory map 700 that may be generated by the server 120 based on the trajectories of the trajectory data 600 illustrated in FIG. 6. The trajectory map 700 may be comparable to the transaction map 500 described above, but replaces the individual transactions with the trajectories (1)-(4) made up of those transactions. In performing this transformation, the server 120 may omit nodes that are not identified as a source or destination of any trajectories, and therefore operate as via points with respect to the trajectories. For example, the transaction map 500 includes nodes A and B, while the trajectory map 700 omits those nodes. Individual transactions that are not determined to be a component of any trajectory may be omitted from the map 700.

In generating and configuring the trajectory map 700, the server 120 can depict the flow of resources between accounts in a manner that may not be apparent from examining the trajectories themselves. In particular, multiple transactions may be identified as associated with a common flow of resources from and/or to a common node. For example, although the transaction data 142 does not indicate any direct links between node N and node S, the trajectory map 700 clearly illustrates two substantial flows of resources (trajectories (2) and (3)) from N to S. As a result, the server 120 may determine evidence of a range of activity by the account holders that was previously obscured by the transaction data 142.

In order to provide more useful and actionable information about the transactions, the server 120 may perform a range of analytics on the trajectory data 600 (alone or in combination with the transaction data 142). For example, the server 120 may filter the trajectories by one or more categories such as transaction type sequence, total duration, resource amount, respective source, destination, and/or location. The map 700 may be updated following such filtering to illustrate the trajectories or other features of interest. Further, the server 120 can expand on or characterize the map 700 based on trajectory data of interest. For example, the trajectories (1)-(4) can be updated or altered with visual indicia to indicate sources or destinations in common with other trajectories, duration, amount transferred, location(s), and/or transaction type sequences. The server 120 may also depict the trajectories (1)-(4) as one of a variety of different shapes or patterns to indicate different geographical locations traversed by the trajectory. For example, the trajectory map 700 may be superimposed on a geographic map (e.g., a world or multi-nation map), and the trajectories (1)-(4) may be depicted as curved or multi-point connections that depict the source and destination of the trajectory, as well as (optionally) one or more via points through which the trajectory traverses.

Further, the server 120 may compare a subset of the trajectory data against one or more thresholds to determine whether one or more account holders or financial institutions have potentially violated a law, regulation or other standard. For example, a large number of deposits corresponding to a common trajectory, conditioned on exceeding a deposit quantity threshold and being within a resource quantity threshold, may indicate an instance of fraud (e.g., commission gaming). As another example, a large number of trajectories with common end points and numerous distinct via points, where the fraction of resource quantity accounted for by any one trajectory dips below a threshold, may indicate an instance of money laundering. Other thresholds may be set and tested by the trajectory data to determine a range of violations, including fraud, money laundering, and terrorism financing. Such a violation may be reported to a user, accompanied by actionable information such as the account holder party to the transactions making up the trajectory, and other details of the transactions.

Example Application: Mobile Money Transfers

Example embodiments as described above may be implemented to process a large dataset of mobile money transaction records from a provider, which covers ten months of activity for millions of users. Mobile money is a new global industry that has expanded rapidly across Africa, South Asia, and Southeast Asia since the late 2000s. Mobile money providers support a digital version of the local currency (e-money). They host e-money accounts, process transfers, and service payments for users over their cellular infrastructure, where digital transactions are instantaneous. Digital services are facilitated by a large cadre of on-the-ground mobile money agents. These agents represent the provider and are physically located in the area they service. Mobile money agents offer conversion between cash and e-money, as would a teller, but they run their own operations often in conjunction with a retail shop. Mobile money agents are paid on commission.

Well-known use cases for mobile money, such as digital payments, digital transfers, and money storage, generally involve several sequential transactions of different types. For instance, paying a bill using the mobile money system might entail first depositing cash and then making a digital payment. Common sequential patterns, referred to as “motifs,” are suitable for isolating the most common actions taken by mobile money users. To study these sequences empirically, e-money may be traced as it moves through the mobile money system.

Example embodiments provide data transformation that turns financial transaction records into a dataset of observed transaction sequences—balance-respecting trajectories. Each trajectory may represent a specific amount of money observed to move through a specific sequence of accounts following a particular motif. In the language of monetary economics, balance-respecting trajectories represent observed monetary flows. The rules of basic accounting can be referenced to build out trajectories, respecting the balance in every account at every point in time. Accounting guarantees that the movement of money is a conservative process; money does indeed flow. In the language of the language of network science, conservative processes are walk processes and balance-respecting trajectories are observed instances of a walk process.

E-money can be traced from when it enters the mobile money system to when it exits, and group observed trajectories by the motif they follow. Example embodiments can create aggregated entry-exit networks where the nodes are the mobile money agents or corporations at the start and end of the observed trajectories. The links can be weighted to represent the movement of money, or the absolute flow of money, through the mobile money system as a whole. The trajectories that begin with cash deposits to agents, and the aggregated networks that gives each deposit equal weight, may be a point of focus.

Each user activity moves money through a different network structure at the system scale: digital payments result in a hub-and-spoke network, digital transfers form a largely amorphous network, while money storage and other activity that involves no digital transactions creates a network with geographic assortativity. Within this last network, example embodiments can uncover systematic gaming of the commissions system by a small subset of mobile money agents. This fraudulent behavior appears to be coordinated within scores of small, isolated groups of agents. In each case, trajectories let us observe individuals' actions and aggregate their effect on the movement of money up to the scale of the entire system.

Example embodiments can also reveal that user activity moves e-money through the corresponding motifs in anywhere from minutes to months, thus returning that e-money to provider-facing accounts at substantially different rates. There are differences in these distributions between activities: commission gaming and bill payments happen considerably faster, on average, than do person-to-person transfers. But more importantly, the underlying distribution in return time for each of the activities range across several orders of magnitude. Empirical heterogeneity in turnover times greatly complicates estimation and interpretation of the velocity of money, a related theoretical concept from macroeconomics, at smaller scales.

Example embodiments provide tools of network science, current and future, into reach for studying how money moves within payment systems. Conceptually, the network structure of money flow within an economy is a different angle from which to consider the interaction of scales in economics. Trajectory-based network analysis of empirical monetary flows at native resolution can quantify this structure. Network analysis could provide another way to measure the economic power of “hubs” (ex. large firms) or the economic independence of “communities” (ex. regions). Moreover, payment systems themselves are what connect the monetary system to the underlying economy. Balance-respecting trajectories remain interpretable as the flow of money, and can provide an empirical grounding for ambitious lines of inquiry in monetary economics.

Mobile Money Data

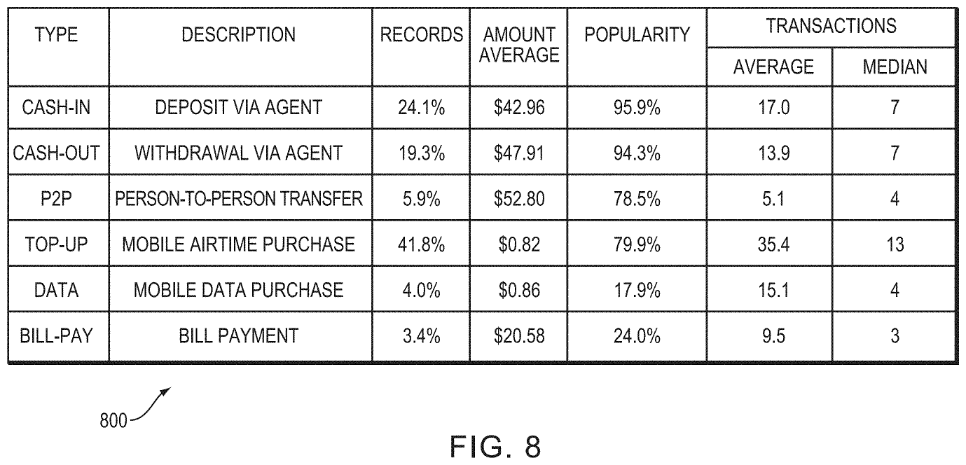

FIG. 8 is a table summarizing the mobile money transaction data of the aforementioned mobile money transactions over a 10-month period, which contains over 300 million transaction records generated by over 5 million anonymous users. This activity was facilitated by over 40,000 anonymous mobile money agents. Each record includes the sender, recipient, time stamp, amount, fee, type, and resulting balances of each transaction. The most common transaction types are summarized in FIG. 1. Users can deposit money by giving cash to a mobile money agent, who then places e-money onto their account (cash-in). A withdrawal reverses this process (cash-out). Users can transfer e-money to other users using the person-to-person (p2p) service. Bill payment transactions (bill-pay) are payments to utilities or other large corporations. Mobile airtime (top-up) and mobile data (data) purchases are payments to the provider. Generally, mobile airtime and mobile data purchases are micro-transactions in that they are orders of magnitude smaller than other transaction types.

FIG. 8 shows that most transactions are ones where e-money either enters or exits the system; the network boundary is very prominent. Deposits and withdrawals of e-money are the most popular, in that such transactions are made by the largest fraction of users. Indeed, mobile money recipients often choose to withdraw their e-money into cash straight away rather than to keep it in their accounts or send it onward. Mobile airtime purchases are the most common type of transaction in the data, and they are indeed small. Person-to-person transfers, which keep e-money in circulation, are also popular but users make fewer of them so they are less common in the data. It is worth noting that surveys of users show that person-to-person transfers are the most popular service indicating that users do not consider deposits and withdrawals to be separate actions, necessarily.

Given the salience of the network boundary, oft-described use cases for mobile money can be categorized as sequential patterns of transaction types—motifs (also referred to as transaction type sequences). Paying a bill using the mobile money system would generally entail a cash-in transaction followed by a bill-pay transaction. Similarly, e-money from a cash-in can be used to purchase mobile airtime or mobile data. These are all well-known use cases of mobile money systems. Another prototypical sequential pattern is the digital transfer motif, which involves three transactions: a cash-in, then a p2p, and then a cash-out. Note that p2p transactions that are not subsequently withdrawn keep money in circulation within the mobile money system.

E-money from a cash deposit can also be withdrawn again into cash without undergoing any digital transactions at all. This creates an in-out motif that is fairly common in mobile money systems, and there are several accepted explanations. This use case may be described as money storage, a way to avoid carrying cash while travelling and to avoid storing cash at home over the short or medium term. Money stored over a longer period of time becomes savings, so this sequential pattern would also occur if users were maintaining e-money in their mobile money accounts as a form of savings. This is less common. Informal, over-the-counter, person-to-person transfers can also create the in-out motif. Often called a direct deposit, this action avoids the p2p transaction step; the sender cashes in to the recipient's account, rather than their own, with the cooperation of (or at the behest of) the depositing agent.

Sequential transactions following the in-out motif might also arise from opportunism on the part of mobile money agents. Encouraging and exploiting over-the-counter transfers is one of several ways by which agents could game mobile money systems so as to raise their earnings. More directly, agents can manipulate official commissions by acting strategically. Gaming is possible because agents earn a commission for facilitating both cash-ins and cash-outs, while providers earn revenue from this activity only from transaction fees charged on the cash-outs. Furthermore, agent commissions have a tiered structure. Agents can take advantage by splitting larger cash-in transactions into several smaller ones nearer the tier, effectively collecting multiple commissions for a single deposit. Since deposits incur no provider-imposed fee, this can be taken to an extreme and agents have been known to control user accounts for the sole purpose of earning themselves commissions. Under the commission structure of this particular provider, such brazen gaming would entail making many small deposits (maximizing the commission) and fewer large withdrawals (minimizing the provider-imposed fee). Since commission gaming comes at the expense of the mobile money provider, this whole range of actions are generally considered fraudulent.

Trajectory Transformation

Example embodiments provide for analyzing sequences of transactions. To do this, a data transformation that recovers empirical transaction sequences from financial transaction data can be defined. This “follow-the-money” transformation traces e-money from when it enters the mobile money system to when it leaves, noting the accounts that those funds pass through along the way. The result is a set of data objects referred to as balance-respecting trajectories, which represent a specific amount of money observed to move through a specific sequence of accounts via a particular sequence of transactions.

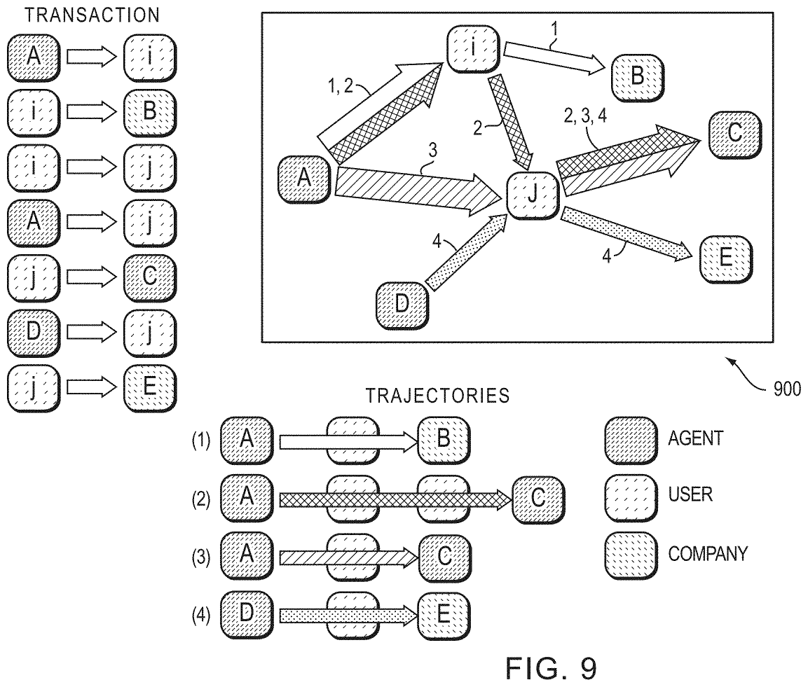

FIG. 9 is a map 900 depicting transactions in one embodiment. An ordered series of deposits, transfers, payments, and withdrawals (left) create a transaction network at center. Arrows show the movement of e-money. Pieces of these transactions are allocated into balance-respecting trajectories (listed at right). Trajectories represent the movement of e-money from depositing agents, through users, and on to companies and withdrawing agents. Trajectories (1)-(4) follow micro-payment, digital transfer, in-out, and bill payment motifs, respectively. FIG. 9 illustrates this transformation for a simple series of transactions among mobile money agents, users, and companies. The arrows represent the movement of e-money, and the resulting set of balance-respecting trajectories follow motifs that correspond to those typical of mobile money systems. Trajectory (4) follows the payment motif, where a user receives e-money via a cash deposit and subsequently uses it for a bill payment. A similar sequence where the funds are used for a mobile airtime or data purchase would form a micro-payment trajectory (1). Trajectory (3) follows the in-out motif, where a user makes a deposit only to cash the e-money back out without ever using it for a digital transaction.

Algorithmic Implementation

Example embodiments may implement a data transformation process using a dynamic programming algorithm that funds outgoing transactions using e-money from prior incoming transactions. This algorithm may record intermediate objects, branches, that represent portions of transactions. Root branches are portions of transactions that begin trajectories. As new transactions appear, existing branches provide the funds to service them, building up a tree-like structure of references. Leaf branches are portions of transactions that end trajectories. Once the algorithm reaches a leaf branch, it has uncovered a complete trajectory and recursively traverses back toward the root branch. The sequence of transactions, nodes, and durations encountered on the way back to the root branch become the basic features of that balance-respecting trajectory. The process may be implemented concurrently for all accounts in the system as transactions appear in sequence or in continuous time.

Allocation heuristic: Which existing funds to allocate to which outgoing transactions is not uniquely defined; money is fungible. Funds can be allocated using a last-in-first-out or “greedy” heuristic. In the context of mobile money data, this heuristic ensures that a user who deposits $100 through a mobile money agent, and then promptly pays a $100 utility bill, will generate a straightforward $100 e-money trajectory from the agent that processed their deposit, through their account, and on to the utility.

Network boundary: What transactions are root, leaf, and regular branches will depend on the bookkeeping practices of the particular provider. The network boundary may be defined using the transaction types supplied in the data so as to trace all user-facing mobile money transactions. Transactions with a type that deposits e-money onto user accounts are defined to be root branches, while payments and withdrawals are defined to be leaf branches. The senders (recipients) of cash-in (cash-out) transactions are mobile money agents. The recipients of mobile airtime, mobile data, and bill payment transactions are corporations.

Financial transactions move money. Transactions that break accounting rules, such as spending a dollar more than once, may be prohibited, and payment systems see to it that they do not occur. In practice, accounting can be done in a decentralized manner (cash), a centralized manner (checking), or even algorithmically (blockchain). Either way, providers must enforce accounting or risk being forced to honor duplicated funds using money of their own. Because transactions can only be made using funds that already exist in the system, money is conserved. That accounting conserves money is even reflected in the terms used to describe the dynamics of money, like flow and circulation.

Results

Observed trajectories of e-money through the mobile money system that begin with cash-in transactions can be collected, and then grouped by the motifs they follow. A first group combines all trajectories that end in a bill payment or micro-payment, and these motifs together capture 12.7% of cash-in transactions. The next group encompasses the prototypical digital transfer motif, as well as similar motifs with more than one person-to-person transaction. These motifs also capture 12.7% of cash-in transactions. Finally, all of the trajectories can be aggregated together following the in-out motif, which reflects money storage or other activity that involves no digital transactions. 71.5% of cash-in transactions follow this motif. For each of these groups of motifs, entry-exit networks that describe the resulting movement of e-money through the system can be created. The nodes in these networks are the mobile money agents or corporations at the start or end of each observed trajectory. The links between them are directed, and each deposit can be given equal weight in calculating the aggregated link weight. The weighted out-degree of an agent corresponds to the number of cash-ins they facilitated that went on to follow a motif in that group. These networks represent the movement of money through the mobile money system as a whole, emphasizing the activity of users rather than the absolute flow of money, which would be strongly affected by the largest transactions.

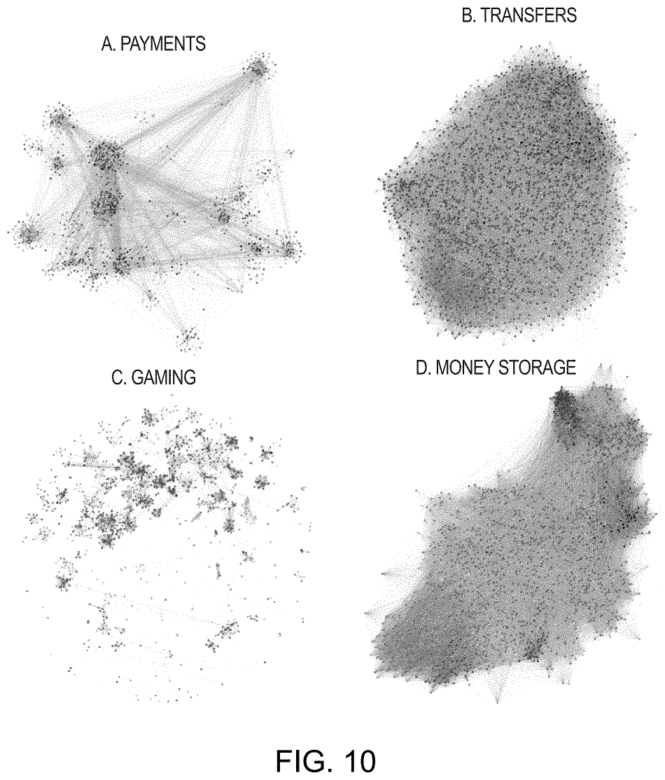

FIG. 10 illustrates sub-networks of trajectories generated from the transaction data having a 4000-node core. Sub-network (A) depicts digital payments, and sub-network (B) depicts digital transfer networks. The network of aggregated in-out trajectories shows a distinct structure among 1500 nodes of the innermost core likely engaging in commission gaming as shown in sub-network (C), and the 4000 nodes in the next tier facilitating money storage (as shown in sub-network (D)) or other non-digital activity. The top 10% most significant links are displayed; isolates are hidden. Nodes may be colored by geographic location at the highest sub-national administrative areas in the country, when known from cellular records. Agents who joined the network too recently for this (about half) are dark grey. Corporations are black points, and appear only at the center of the hubs in (A).

Mobile money facilitates four distinguishable economic actions: digital payments, digital transfers, commission gaming, and money storage or other non-digital activity. These activities move money through the system to form four decidedly different network structures: hub-and-spoke, amorphous, tightly grouped, and geographically assortative. FIG. 10 visualizes the weighted core of our three aggregated networks, showing the top 10% most significant links within the core. The structure of sub-network (A) (digital payments) and sub-network (B) (digital transfers) appear strikingly different. When making digital payments, users move e-money from agents all over the country into the accounts of a handful of large corporations, who become the obvious hubs. In contrast, users making digital transfers move e-money through the system from everywhere to everywhere else in a manner that appears very close to random. Weighted k-core analysis reveals two distinct structural patterns within the in-out network. The innermost core of 1500 agents capture 13.1% of all cash-in transactions as in-out motifs just among themselves as shown in sub-network (C). These agents form small and densely connected subgroups that are less connected to one another. This differs substantially from the structure among the next tier of 4000 agents that is indicative of the structure of the bulk of the in-out network and shows a general geographic assortativity as shown in sub-network (D).

Evidence for systematic commission gaming: The innermost core of the in-out entry-exit network may reflect systematic commission gaming. These 1500 mobile money agents are a rather distinct set: only 7.6% of them are also at the core of the payment or transfer networks, whereas this number is 51.7% for the next 4000 by core number. The errant set includes less than 4% of all agents, and they distinguish themselves with behavior that is consistent with engaging in systematic commission gaming. The average mobile money agent earns as commission 95.0% of the fee revenue that they generate for the provider in facilitating cash-ins and cash-outs. The provider's break-even point is clearly somewhere below 100%. On average, these 1500 agents earn as commission fully 231.9% of the revenue they generate for the provider. There is evidence that these agents are splitting deposits to reach such high commissions. While they serve about as many unique customers as does the average agent, these agents facilitate many times more cash-in deposits that are many times smaller. Moreover, a cash-in with one of these agents is four times as likely to fall within $1 of a tier in the commission structure as one with an average agent. This is clear evidence of gaming. Finally, these agents facilitate almost no digital transactions; 95.0% of their cash-ins follow the in-out motif. This means they may also be encouraging and exploiting over-the-counter transfers to raise their earnings further.

Money storage and other non-digital activity: Without the errant contingent of agents, the in-out entry-exit network reflects regular mobile money activity that involves no digital transactions. The established explanation for such activity is money storage, but in our case it likely includes also mobile savings and over-the-counter transfers to some extent. In other mobile money systems, such as those with designated over-the-counter or savings services, it may be possible to distinguish these actions.

Network Structure of Economic Activities

Network measures can quantify structural differences in the patterns of money flow created by the four distinguishable actions. The information-theoretic measure employed in the community detection algorithm Infomap can be used to quantify the extent of sub-network structure. This measure gives the average number of bits needed to describe one step in an infinite random walk on the network, and the algorithm exploits sub-network structure to minimize that value. The value of the measure under compression can be compared to that of the uncompressed network. Random networks cannot be compressed, remaining near 0% compression, while a network with increasingly rich multilevel subgroup organization would approach 100% compression. To quantify the extent of geographic assortativity, embodiments can calculate the generalized modularity using the geographic locations of agents at the highest sub-national administrative areas in the country, when this could be inferred from cellular records. This measure compares the amount of money moving between nodes within the same module to that which would be expected at random, and can range from −1 to 1. A value of 0 corresponds to random expectation; a value of 1 corresponds to a network where money moves only between agents within the same geographic area.

Pronounced subgroups in the structure of commission gaming: As described above, the mobile money agents are acting strategically, in that their behavior reflects the fee and commission scheme. These also move money amongst each other primarily within small subgroups, a curious network structure that may reflect deliberate coordination. This activity captures 13.1% of cash-in transactions. Infomap achieves a full 63.2% reduction in description length of the network, indicating that this network contains rich multilevel subgroup structure. Cash is often deposited and withdrawn from agents within the same groups of around ten agents. Although this is one particular case, this finding suggests that our analysis approach can surface particular kinds of strategic coordination, whether or not they are desirable, within payment systems. Example embodiments may flag individual in-out sequences with specific evidence of agent wrongdoing, thereby enabling users to further isolate and characterize commission gaming.

Geographic assortativity in the structure of money storage and other non-digital activity: Regular in-out activity captures a remarkable 58.4% of cash-in transactions, with an internal community structure driven by geography. This is an unexpectedly large share of all activity; the system is intended for digital transfers and they are the most popular service according to surveys. However, behavioral trace data carries different observational implications than do stratified surveys. In particular, the median mobile money transaction is not made by the median user, but rather by an especially active user who makes many transactions. Money storage and other non-digital activity is prominent in the data because it reflects an important use-case among high-activity users. This activity is structured by geography. Infomap achieves a 5.6% reduction in the description length as it finds community structure to the non-digital network. A generalized modularity of 0.27 by geographic location indicates that this structure is aligned with geography.

Randomness in the structure of digital transfers: Digital transfer activity captures 12.7% of cash-in transactions and forms an amorphous network with near-random structure. In contrast to the other usecases, Infomap recovers next to no structure within the network of digital transfer activity. The algorithm achieves a negligible 0.06% reduction in description length. Digital transfers show some geographic assortativity, with a modularity of 0.13, but little centralization. The 4000 agents at the core process 2.6% of the cash-in transactions moving over it, which is not much more than naive expectation. That the structure of digital transfers is stubbornly amorphous is quite surprising, especially since mobile money has been unevenly adopted following existing contours of socioeconomic inequality. Much as those supporting the development of mobile money would like to pinpoint areas where digital circulation is succeeding especially well, this is not possible in this particular case.

Prominent hubs in the structure of digital payments: Digital payment activity captures 12.7% of cash-in transactions, and these funds end up paid to just over 300 corporate accounts. The large corporations who receive payments are “hubs” that hold prominent positions with respect to the movement of money within this mobile money system. The provider itself is one of these, as they are the recipient of e-money used to purchase mobile airtime and mobile data.

Temporal Structure of Economic Activities

Digital payments, digital transfers, commission gaming, and money storage or other nondigital activity also show different temporal structure. The trajectories corresponding to these activities move through the mobile money system over a period of time, and the profile of these durations differs substantially.

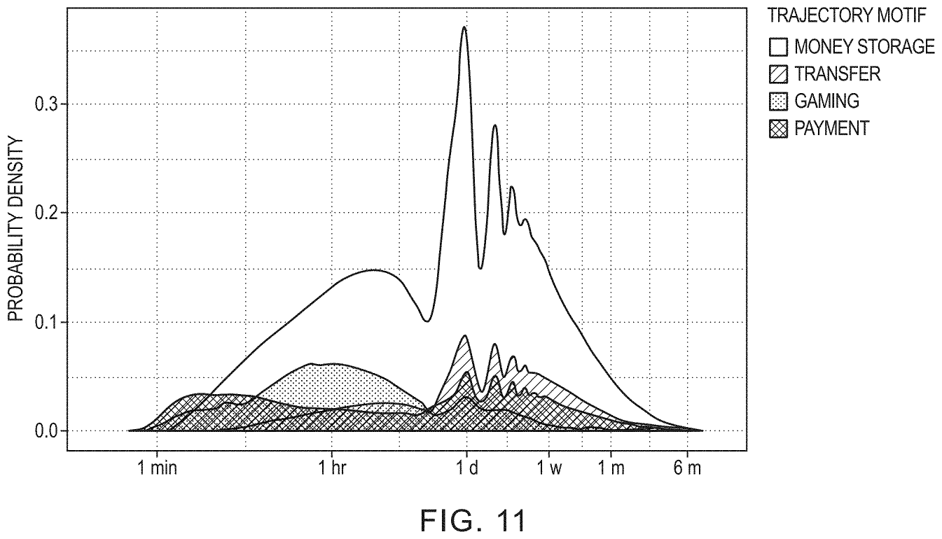

FIG. 11 is a graph depicting the distribution of trajectory durations that may be a product of trajectory analytics in an example embodiment, scaled and weighted to reflect the proportion of cash-in transactions captured by each activity. The distribution over the duration of time between cash-in transactions (that begin trajectories) and payment or withdrawal transactions (that end trajectories). Shown in color are the four distinguishable economic actions identified above. The distribution is weighted such that each cash-in contributes one observation, and the areas are scaled to reflect the proportion of cash-in transactions captured by each activity. The x-axes are log scaled.

The temporal structure of commission gaming and of digital transfers have the least overlap. Most commission gaming occurs within the same day while the majority of digital transfers take more than one day to move through the system. Digital payments show a bi-modal distribution, reflecting differences in two of the constituent actions: bill payments and micro payments. Cash-in deposits intended for bill payments routinely exit the system within a few minutes to an hour. Mobile airtime and mobile data purchases, on the other hand, are often made using the small sums that have remained in a mobile money account for days or even weeks. Money storage and other non-digital activity shows a very broad distribution, underscoring the difficulty in distinguishing actions that leave similar behavioral traces in the data.

Notably, a wide variation in the duration distribution may be seen within each activity. Differences can be expected across use-cases in the amount of time e-money remains in the mobile money system. Most of the e-money visible is used by those with rapid turn-over, but at any given moment most of the e-money in the system is held by those with slow turn-over. The results show that such effects also within any particular economic activity on mobile money systems should be addressed. Indeed, the underlying duration distribution is logarithmic. When values range across several orders of magnitude, the average becomes uncharacteristic of the distribution. The velocity of money is a theoretical concept defined by macroeconomic accounting relationships between money supply and price level, and is often treated as a single average value across an economy. It is related to the “transactions velocity,” and there are methods that estimate the economy-wide velocity of money when average turnover rates differ across payment systems or sectors. Such methods may be extended to incorporate heterogeneity also within payment systems.

Example embodiments may include a computer program product, including a non-transitory computer-readable medium (e.g., a removable storage medium such as one or more DVD-ROM's, CD-ROM's, diskettes, tapes, etc.) that provides at least a portion of the software instructions for the invention system. The computer program product can be installed by any suitable software installation procedure, as is well known in the art. In another embodiment, at least a portion of the software instructions may also be downloaded over a cable communication and/or wireless connection. The computer program product may be transmitted via a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for routines/programs of example embodiments.

While example embodiments have been particularly shown and described, it will be understood by those skilled in the art that various changes in form and details may be made therein without departing from the scope of the embodiments encompassed by the appended claims.

What is claimed is:

1. A computer-implemented method of analyzing transactions in a centralized clearing system, the method comprising:
converting representations of individual transactions of units of value into representations of trajectories representing a reduced number of units of value, the representations of trajectories composing flow paths of the units of value from origins to destinations;
applying a coarse graining computer-implemented method to the representations of trajectories, the coarse graining computer-implemented method producing a reduced number of representations of trajectories that compose a flow network from the origins to the destinations; and
applying a network analysis to the flow network to produce analytics of the transactions in the centralized clearing system.

2. The method of claim 1, further comprising categorizing trajectories prior to applying the coarse graining, the categorizing assigning the representation of trajectories into categories of transaction type sequences including at least:
a) deposit and payment/withdrawal; and
b) deposit, transfer, and payment/withdrawal.

3. The method of claim 1, wherein:
a) at least a subset of flow paths includes via points between the origins and destinations; and
b) the coarse graining removes at least a subset of the via points.

4. The method of claim 3, further comprising reintroducing a subset of via points or constituent transactions after applying the coarse graining responsive to an automated or user input.

5. The method of claim 1, further comprising displaying the representations of trajectories or the analytics at a graphical user interface (GUI).

6. The method of claim 5, further comprising displaying at least a subset of the representations in the GUI with at least one of color coding, geographical markers, or indicia highlighting a feature of the analytics.

7. The method of claim 1, wherein the transactions include transfers of tangible or intangible units of value, the intangible units of value including at least one financial instrument of money, bonds, and stocks.

8. The method of claim 1, further comprising identifying, based on the analytics of the transactions, at least one violation, the violation including at least one of a fraud, money laundering, and terrorism financing.

9. A computer-implemented method of processing financial transactions, comprising:
obtaining a transaction data set, entries of the transaction data set including a sender, a recipient, and a transferred amount;
defining trajectories from the transaction data set, each of the trajectories having a source and a destination and indicating a flow of a given resource through at least one via point based on a plurality of transactions of the transaction data set, the given resource being a function of the transferred amounts of the plurality of transactions;
identifying a violation based on whether a metric of at least one of the trajectories exceeds a predetermined threshold; and
reporting the violation to a user.

10. The method of claim 9, wherein the at least one via point indicates an entity identified as 1) a recipient in a first transaction and 2) a sender in a second transaction.

11. The method of claim 10, wherein defining the trajectories includes defining a trajectory integrating the first and second transactions, the trajectory indicating the flow of the given resource from a sender in the first transaction to a recipient in the second transaction.

12. The method of claim 9, further comprising applying a course-graining to the trajectories, the coarse-graining including eliminating the at least one via point from the trajectories.

13. The method of claim 9, further comprising applying a coarse-graining to the trajectories, the coarse-graining including combining a plurality of trajectories into a combined trajectory based on at least one of a common source, a common destination, and a common time range.

14. The method of claim 13, further comprising determining a resource amount of the combined trajectory based on at least one of resource amounts of each of the plurality of trajectories and the resource amount of the plurality of associated transactions

15. The method of claim 13, further comprising determining a resource amount of the combined trajectory based on the resource amounts of each of the plurality of trajectories.

16. The method of claim 9, further comprising categorizing the trajectories into a plurality of categories of transaction type sequences, the categories including at least one of 1) deposit and payment/withdrawal, 2) deposit, transfer, and payment/withdrawal.

17. The method of claim 9, further comprising categorizing the trajectories into a plurality of categories based on at least one of 1) total duration, 2) resource amount, and 3) location.

18. The method of claim 9, further comprising:
identifying at least one transaction of the transaction data set associated with the violation; and
wherein reporting the violation includes an indication of the at least one transaction.

19. The method of claim 9 further comprising filtering the trajectories based on at least one of source, destination, resource quantity, duration, and transaction type sequence.

20. The method of claim 9, further comprising generating a map relating the trajectories based on common sources and destinations.

21. The method of claim 9, wherein at least one of the trajectories is a function of a fee assessed by a payment system for transferring the given resource.

22. The method of claim 9, further comprising defining the trajectories based on at least one of a last-in-first-out allocation and a well-mixed allocation of the resource.

23. A computer-implemented method of processing financial transactions, comprising:
obtaining a transaction data set, entries of the transaction data set including a sender, a recipient, and a transferred amount;
defining trajectories from the transaction data set, each of the trajectories having a source and a destination and indicating a flow of a given resource through at least one via point based on a plurality of transactions of the transaction data set, the given resource being a function of the transferred amounts of the plurality of transactions;
generating a map relating the trajectories based on common sources and destinations;
applying a network analysis to the map to produce analytics of the plurality of transactions; and
reporting the analytics to a user.

24. A computer-implemented method of ranking and segmenting accounts in a centralized clearing system, the method comprising:
obtaining a data set of transactions processed by the centralized clearing system, entries of the transaction data set including a sender, a recipient, and a transferred amount;
converting representations of individual transactions of units of value into representations of trajectories composing flow paths of the units of value from origins to destinations via at least one account of the centralized clearing system;
generating at least one metric defined for a plurality of accounts, the metric being constructed for each account based on the one or more trajectories where that account is a via point, the metric thereby characterizing the behavior of accounts with respect to the flow of units of value;
applying a sorting or clustering analysis to at least one metric for a plurality of accounts, having this analysis return a ranking or segmentation of accounts; and
reporting the account ranking or segmentation to a user.

25. The method of claim 24, further comprising incorporating a timestamp included in the transaction data set to define a duration at each account along each flow path, the metric being constructed for each account based on the duration of time where that account is a via point for one or more trajectories.

26. The method of claim 24 further comprising defining the metric based on ancillary entries of at least one transaction of the transaction data set associated with the trajectories where that account is a via point.
